(19) United States
(12) Patent Application Publication
(10) Pub. No.: US 2005/0030435 A1
(43) Pub. Date: Feb. 10, 2005

(54) Image forming method and apparatus

(75) Inventor: Takayuki Uemura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/836,599

(22) Filed: May 3, 2004

(30) Foreign Application Priority Data
May 2, 2003 (JP) 2003-127331

(51) Int. Cl. H04N 9/12

(52) U.S. Cl. 348/742

(57) ABSTRACT

When an image forming material is exposed to light beams to form an image, the image forming method and apparatus set a first light quantity level and a second light quantity level that is higher than the first light quantity level, adjusts a pixel recording time period of a pixel signal to be subjected to pixel recording, and generates a first signal and a second signal for driving the first light quantity level and the second light quantity level based on the pixel signal, respectively. In this method and apparatus, the pixel recording time period of the pixel signal is adjusted in accordance with a combination of the first signal and the second signal, and the image forming material is exposed to light beams in the first light quantity level and in the second light quantity level based on this combination. The method and apparatus are capable of improving the reproducibility of small points and fine lines and enhancing the image quality.

### BACKGROUND OF THE INVENTION

1. Field of the Invention

The present invention relates to a method and an apparatus for image formation, and more particularly to an exposure control technique used at the time of image formation by an exposure optical device in which an image is formed using plural exposure optical systems.

2. Description of the Related Art

In recent years, a computer to plate system (hereinafter referred to as CTP system) has been used more and more widely. In the CTP system, a digital image is created using a computer and image recording is performed directly on a printing plate without using a film at the time of plate making. As an image forming apparatus used in the CTP system or the like, is used an image forming apparatus that forms an image by performing laser light exposure in accordance with a digital image signal while holding an image forming material such as a light and heat sensitive material, a heat mode recording material or a light sensitive material on the surface of a rotating drum.

With this technique, the turned-on state of a light beam emitted from an exposure light source is controlled using a binary image signal generated based on the image data of an original image to be recorded and the image forming material is two-dimensionally scanned with the light beam by relatively moving the exposure light source and the image forming material. In this manner, a desired image is formed on the image forming material.

An image for plate making is a halftone dot image composed of so-called halftone dots and each halftone dot is recorded by a set of many dots formed through scan exposure using a light beam having a certain size determined in accordance with a resolution.

In a conventional apparatus that forms an image on a thermal plate for printing, in order to improve the reproducibility of small points and fine lines, a beam diameter is narrowed and a light quantity is increased.

If the light quantity is increased too much, however, there occur problems such as the off-balance between white lines and black lines, the occurrence of aberration, the generation of image defects, and the shortening of the life span of a laser. In particular, when a beam diameter is not narrowed, the off-balance between white lines and black lines appears conspicuously. Therefore, it has been difficult to perform a setting at an optimum light quantity.

As a countermeasure against these problems, for instance, a method is proposed with which the brightness of a light source is increased at the time of exposure of a contour portion of an image to be recorded on an image forming material and the edge of the contour portion is sharpened in density through edge enhancement based on differentiation of a binary signal (see JP 08-023422 A, for instance).

With the method described in the above patent document 1, however, the edge enhancement is performed in proportion to a set light quantity, so that when a laser used has non-linear characteristics, it is impossible to adjust the ratio of the edge enhancement. Consequently, there occurs a problem that it is impossible to perform an optimum light quantity setting.

Also, at the time of defocusing, a beam shape is changed, which causes variations in the recording line width determined by an image forming material threshold value. Also in the case where sensitivity variations occur, the image forming material threshold val is changed and the recording line width varies. In such a case, there occurs a problem that the reproducibility of small points and fine lines is degraded and the degradation in image quality such as change of the halftone dot area ratio and image unevenness occurs.

### SUMMARY OF THE INVENTION

The present invention has been made in view of the conventional problems described above and is aimed at providing a method and an apparatus for image formation that are capable of improving the reproducibility of small dots and fine lines and enhancing the image quality.

In order to attain the above object, a first aspect of the present invention provides an image forming method in which an image-forming material is exposed to-light beams to form an image, comprising a step of setting a first light quantity level and a second light quantity level that is higher than the first light quantity level or a predetermined light quantity level representing a difference between the second light quantity level and the first light quantity level, a step of adjusting a pixel recording time period of a pixel signal to be subjected to pixel recording for forming the image on the image forming material, a step of generating a first signal for driving the first light quantity level based on the pixel signal; and a step of generating a second signal for driving the second light quantity level or the predetermined light quantity level based on the pixel signal, wherein the pixel recording time period of the pixel signal is adjusted in accordance with a combination of the first signal and the second signal, and wherein the image forming material is exposed to the light beams in the first light quantity level and in the second light quantity level based on the combination of the first signal and the second signal thereby performing the pixel recording on the image forming material.

Preferably, the first signal is the pixel signal for driving the first light quantity level, the second signal is an edge signal for the pixel signal which drives the predetermined light quantity level, and wherein the predetermined light quantity level is added to the first light quantity level to obtain the second light quantity level, or the predetermined light quantity level is subtracted from the second light quantity level to obtain the first light quantity level.

And, preferably, the second signal is an edge signal for the pixel signal, the first signal is a residual signal obtained by subtracting the edge signal from the pixel signal, and wherein the residual signal is used to drive the first light quantity level and the edge signal is used to drive the second light quantity level.

Preferably, a delayed pixel signal is generated by detecting a raising edge portion and a falling edge portion of the pixel signal, generating a first timing delayed from the raising edge portion of the pixel signal by an edge signal time period, setting the delayed pixel signal at the first timing, generating a second timing delayed from the falling edge portion of the pixel signal by the edge signal time period, and resetting the delayed pixel signal at the second timing, and wherein a third timing delayed from the raising edge portion of the delayed pixel signal by the edge signal time period is generated, a first edge signal in the raising edge portion of the delayed pixel signal is generated at the first timing and the third timing, and a second edge signal in the falling edge portion of the delayed pixel signal is generated based on the falling edge portion of the pixel signal and the second timing.

Preferably, the edge signal for the pixel signal is obtained as a logical product of the first edge signal and the second edge signal with the delayed pixel signal.

Preferably, the first signal is used to drive the first light quantity level and the second signal is used to drive the second light quantity level, and wherein the first light quantity level is set at a timing at which the first signal for driving the first light quantity level is started, and the second light quantity level is set at a timing at which the second signal for driving the second light quantity level is started.

Preferably, the raising edge portion and the falling edge portion of the pixel signal are detected, the first timing delayed from the raising edge portion of the pixel signal by the edge signal time period is generated and used to set the second light quantity level, the second timing further delayed from the first timing by the edge signal time period is generated, the first light quantity level is set at the second timing, the second light quantity level is set in the raising edge portion, and a third timing delayed from the falling edge portion by the edge signal time period is generated and is used to reset the second light quantity level to an original light quantity level.

Furthermore, in order to attain the above object, a second aspect of the present invention provides an image forming apparatus with which an image forming material is exposed to light beams to form an image, comprising means for adjusting a pixel recording time period of a pixel signal to be subjected to pixel recording for forming the image on the image forming material, means for setting a first light quantity level, means for setting a second light quantity level that is higher than the first light quantity level or a predetermined light-quantity level representing a difference between the second light quantity level and the first light quantity level, means for generating a first signal for driving the first light quantity level based on the pixel signal, and means for generating a second signal for driving the second light quantity level or the predetermined light quantity level based on the pixel signal, wherein the adjusting means adjusts the pixel recording time period of the pixel signal in accordance with a combination of the first signal and the second signal, and wherein the image forming material is exposed to the light beams in the first light quantity level and in the second light quantity level based on the combination of the first signal and the second signal thereby performing the pixel recording on the image forming material.

Preferably, in the image forming apparatus according to the second aspect of the present invention, the first signal is the pixel signal for driving the first light quantity level, the second signal is an edge signal for the pixel signal which drives the predetermined light quantity level, and wherein the image forming apparatus further comprises means for obtaining the second light quantity level by adding the predetermined light quantity level to the first light quantity level, or means for obtaining the first light quantity level by subtracting the predetermined light quantity level from the second light quantity level.

Here, preferably, the second signal is an edge signal for the pixel signal, the first signal is a residual signal obtained by subtracting the edge signal from the pixel signal, and wherein the residual signal is used to drive the first light quantity level and the edge signal is used to drive the second light quantity level.

It is preferable that the image forming apparatus further comprises means for detecting a raising edge portion and a falling edge portion of the pixel signal, means for generating a delayed pixel signal by generating a first timing delayed from the raising edge portion of the pixel signal by an edge signal time period, setting the delayed pixel signal at the first timing, generating a second timing delayed from the falling edge portion of the pixel signal by the edge signal time period, and resetting the delayed pixel signal at the second timing, means for generating a third timing delayed from the raising edge portion of the delayed pixel signal by the edge signal time period and for generating a first edge signal in the raising edge portion of the delayed pixel signal at the first timing and the third timing, and means for generating a second edge signal in the falling edge portion of the delayed pixel signal based on the falling edge portion of the pixel signal and the second timing.

Preferably, the edge signal for the pixel signal is obtained as a logical product of the first edge signal and the second edge signal with the delayed pixel signal.

Preferably, the first signal is used to drive the first light quantity level and the second signal is used to drive the second light quantity level, and wherein the image forming apparatus further comprises means for setting the first light quantity level at a timing at which the first signal for driving the first light quantity level is started, and means for setting the second light quantity level at a timing at which the second signal for driving the second light quantity level is started.

It is also preferable that the image forming apparatus further comprises means for detecting a raising edge portion and a falling edge portion of the pixel signal, means for generating a first timing delayed from the raising edge portion of the pixel signal by an edge signal time period and setting the second light quantity level at the first timing, means for generating a second timing which is further delayed from the first timing by the edge signal time period and setting the first light quantity level-at the second timing, and means for obtaining an original light quantity level by setting the second light quantity level in the falling edge portion, generating a third timing delayed from the falling edge portion by the edge signal time period, and resetting the second light quantity level at the third timing.

According to the first and second aspects of the present invention, by increasing the light quantity only in the edge portions, it becomes possible to eliminate degradation in the reproducibility of small dots or fine lines and degradation in image quality, such as halftone% or evenness, and to improve image quality. In addition, by shortening or elongating the pixel recoding time period in combination with the increasing of the light quantity, it becomes possible to prevent a situation where vertical fine lines and horizontal fine lines become different from each other in line width due to the increasing of the light quantity and to improve image quality.

### BRIEF DESCRIPTION OF THE DRAWINGS

FIG. 1 is a block diagram showing a schematic construction of an embodiment of an image forming apparatus that implements an image forming method according to the present invention;

FIG. 2 is a circuit diagram showing a specific example of the constructions of a clock phase control section and an output signal generation section in a drive signal generator of a main control circuit shown in FIG. 1;

FIG. 3 is a timing chart showing the state of a signal in each portion of the clock phase control section and the output signal generation section whose constructions are schematically shown in FIG. 2;

FIG. 4 is a timing chart showing an example of a process for generating an edge signal in the image forming method according to the present invention;

FIG. 5 is a diagram showing an example of a waveform obtained by increasing a light quantity only in edge portions according to the image forming method of the present invention;

FIG. 6 is a diagram showing another example of the waveform obtained by increasing a light quantity only in edge portions according to the image forming method of the present invention;

FIG. 7 is a diagram showing still another example of the waveform obtained by increasing a light quantity only in edge portions according to the image forming method of the present invention;

FIG. 8 is a diagram showing yet another example of the waveform obtained by increasing a light quantity only in edge portions according to the image forming method of the present invention;

FIG. 9 is a diagram showing another example of the edge signal generation process in the image forming method of the present invention; and

FIG. 10 is a diagram showing still another example of the edge signal generation process in the image forming method of the present invention.

### DETAILED DESCRIPTION OF THE PREFERRED EMBODIMENTS

A method and an apparatus for image formation according to a first and a second aspect of the present invention will now be described in detail based on the preferred embodiments illustrated in the accompanying drawings.

In an embodiment described below, compared to the light quantity level in the other portions, the light quantity level is relatively raised in the rising edge portion and falling edge portion of a laser beam for exposing pixels (e.g., pixel dots) used in image formation on an image forming material. In order to address the difference in line width between vertical fine lines and horizontal fine lines which may occur by raising the light quantity in the edge portions and the degradation in image quality resulting therefrom, the pixel recording time period required for pixel recording is adjusted, for example shortened or elongated in combination with the raising of the light quantity level, whereby the rising edge portion and the falling edge portion of the laser beam (the leading end and the trailing end of the laser beam and, for instance the rising edge portion and the falling edge portion of a binary signal for driving a laser) are set at a light quantity level that is higher than that in a non-edge portion.

Then, the embodiment has the construction described below in order to raise the light quantity level only in the rising edge portion and the falling edge portion of a laser beam.

First, this embodiment has voltage setting means for setting voltage values corresponding to a first light quantity level (target light quantity) and an increased light quantity level (additional light quantity) or a second light quantity level (target light quantity+additional light quantity). For instance, a value corresponding to the first light quantity level (target light quantity) and a value corresponding to the increased light quantity level (additional light quantity) or the second light quantity level (target light quantity+additional light quantity) are set in a target light quantity DAC (digital-to-analog converter) and an additional light quantity DAC or a DAC for a total light quantity of the target light quantity and the additional light quantity, respectively.

In accordance with a pixel signal (pixel modulation signal), the increased light quantity level is added to the first light quantity level or subtracted from the second light quantity level, or the light quantity level is switched from the first light quantity level to the second light quantity level. To be more specific, an image modulation signal and an additional signal which make the outputs from the respective DACs effective are controlled and the outputs from the respective DACs are subjected to the addition or subtraction, or switched from one to the other.

This embodiment also has timing control means which adjusts the timing of the addition, subtraction or switching so as to conform to the raising or falling of a pixel modulation signal.

As a result, when an image is formed by exposure optical systems using light beams, even if the exposure optical systems are different from each other in their positional timing at which the drawing of the light beams is started, the timing control means can be used to perform addition, subtraction or switching between the light quantity levels so that the light quantity level is raised in the rising edge portion and falling edge portion of a laser beam.

Further, although limited only to the edge portions, the increase in the light quantity causes a difference in line width between vertical fine lines and horizontal fine lines, which may degrade the image quality. Therefore, in order to address this problem, the light quantity level is raised in the rising edge portion and falling edge portion of a laser beam, that is, addition, subtraction or switching is performed between the light quantity levels by using the timing control means that also performs in combination adjustment (shortening or elongation) of the pixel recording time period for pixel recording.

In this way, the timing at which the additional signal is given can be controlled at the raising or falling of an image modulation signal whose pixel recording time period has been adjusted, thereby improving the reproducibility of small points and fine lines and enhancing the image quality.

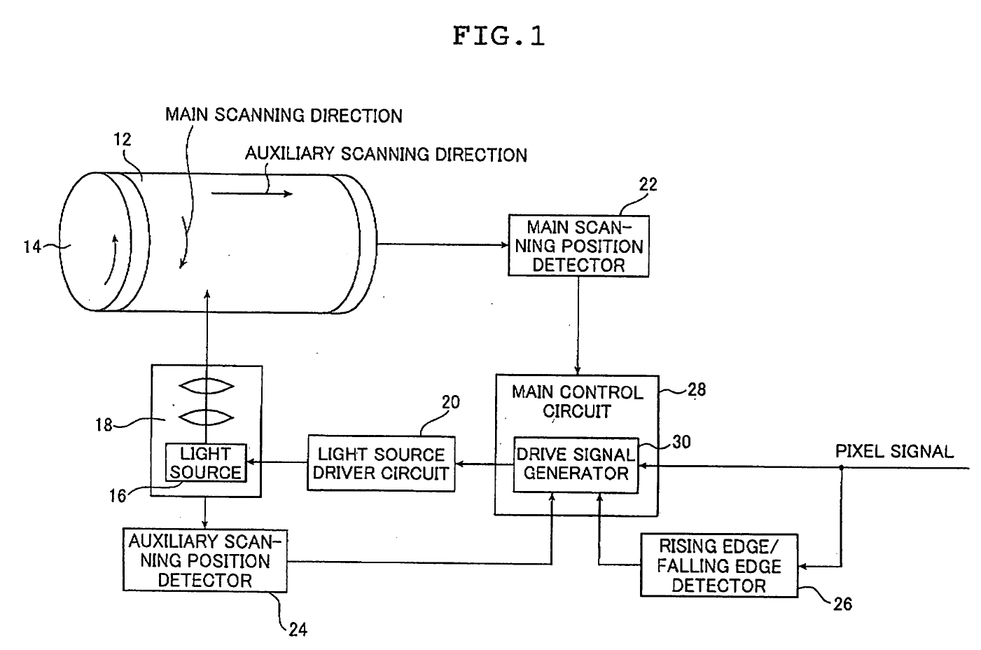

FIG. 1 is a block diagram showing a schematic construction of an embodiment of the image forming apparatus according to the second aspect of the present invention that implements the image forming method according to the first aspect of the present invention.

As shown in FIG. 1, this image forming apparatus 10 includes: a rotation drum 14 for holding an image forming material 12 on which an image is to be formed by exposure and which is wound around the outer peripheral surface of the drum; an auxiliary scanning unit 18 into which a light source unit 16 is built and which is movable along the rotation axis direction of the rotation drum 14; a light source driver circuit 20 that outputs a control signal for driving the light source unit 16; a main scanning position detector 22 that detects the rotational angular position of the rotation drum 14; an auxiliary scanning position detector 24 that detects the rotation axis direction position of the rotation drum 14; a rising edge/falling edge detector 26 that detects the rising edge portion and the falling edge portion of a pixel signal (input modulation signal); a main control circuit 28 that controls the increase of the edge light quantity and the adjustment of the pixel recording time period in the image forming method of the present invention, and also controls each component of the apparatus such as the light source driver circuit 20; and the like.

The image forming apparatus 10 shown in FIG. 1 forms a halftone dot image composed of multiple pixel dots by emitting light beams such as laser beams modulated (ON/OFF controlled) based on individual binary image signals and exposing pixels (pixel dots) to the emitted light beams for recording. The image forming apparatus 10 includes an automatic exposure device of a so-called outer drum type for use in printing plate. The auxiliary scanning unit 18 is moved in the axial direction of the rotation drum 14 by any known moving mechanism (not shown) using a linear guide or a ball screw mechanism. In the present invention, the type of the exposure device is not limited to the outer drum type but the exposure device may be of an inner drum type or a flat bed type.

There is no particular limitation on the image forming material 12 used in the present invention, so long as it is possible to form an image by light beams emitted from a light source such as a laser. More specifically, the image forming material 12 may be a so-called light and heat sensitive recording material or heat mode recording material. The material 12 may also be a so-called light sensitive material which is exposed to light beams to form an image (latent image). Further, a multi-level tone image may be formed on the image forming material 12, but it is particularly preferable to form a binary image including a hydrophobic (ink receptive) portion and a hydrophilic (ink repellent) portion as in a printing plate used in CTP or the like.

The light source unit 16 in the illustrated image forming apparatus 10 may include individually ON/OFF controllable LDs (laser diodes) if they can emit independently modulated (ON/OFF-controlled) light beams. Alternatively, the light source unit 16 may be formed from a combination of a light source emitting continuous light with a modulator, or a combination of a light source such as a broad area array type LD with a spatial light modulator. In the illustrated case, the light source unit 16 is built into the auxiliary scanning unit 18 but this is not the sole case of the present invention. Another form is of course applicable in which the auxiliary scanning unit 18 constitutes an exposure head composed of an imaging optical system for imaging light beams for exposure on the image forming material 12, the light source unit 16 is secured outside the auxiliary scanning unit 18, and the units 16 and 18 are connected with each other via an optical fiber cable array.

The light source driver circuit 20 is a light source driver including an LD driver for driving (ON/OFF controlling) the respective light sources such as the LDs in the light source unit 16 based on light source driving signals generated in a drive signal generator 30 of the main control circuit 28. The function of the light source driver circuit 20 will be described later in detail.

Also, a pixel signal representing image data of an image to be recorded on the image forming material 12 or further resolution data representing the resolution in image recording are supplied from an image supply source (not shown) to the main control circuit 28. In addition, the main control circuit 28 includes the drive signal generator 30 and outputs various signals for controlling the light source driver circuit 20. In more detail, based on each detection signal, the main control circuit 28 outputs an instruction to increase a light quantity, that is, to increase a light emission intensity at a predetermined length (width) in the edge portions of halftone dots constituting the image. In other words, the main control circuit 28 supplies the drive signal generator 30 with the pixel signal for use in image recording based on the light source drive image data, a reference pixel clock for obtaining synchronization timing of the pixel signal, and an N-times pixel clock having a frequency whose period is N times shorter than that of the reference pixel clock.

The drive signal generator 30 uses the thus supplied pixel signal, reference pixel clock and N-times pixel clock to generate an adjusted pixel signal having a pixel recording time period shortened or elongated, that is, adjusted in accordance with the variation in the reproducibility of small points and fine lines or variation in the resolution (halftone dot area ratio) due to the increase in the edge light quantity, and an edge signal for increasing the light quantity in the edge portions of the halftone pixel dots constituting an image. The thus generated adjusted pixel signal and edge signal or a signal synthesized therefrom is then outputted to the light source driver circuit 20.

The main control circuit 28 outputs a light source driving signal for controlling a driving timing at which the light source driver circuit 20 controls each light source of the light source unit 16 and a light quantity level in each light source as well as a timing at which the light quantity is increased in the edge portion and a light quantity level to be raised. However, a driving timing signal having an adjusted (shortened or elongated) pixel recording time period and a timing signal for increasing the light quantity in the edge portions of halftone pixel dots constituting an image may be generated in the drive signal generator 30 and parameters representing the target light quantity level and the light quantity level to be raised in the edge portions which are to be outputted in accordance with the pixel signal are outputted together with the timing signals from the main control circuit 28 to the light source driver circuit 20, where the parameters representing the respective light quantity levels may be set by the respective DACs (digital-to-analog converters) (not shown) to drive the light sources such as the LDs at the set values (e.g., current values) in accordance with the respective timing signals. In other words, the main control circuit 28 may be of a type in which the drive signal generator 30 performs digital signal processing to generate each timing signal which is then subjected to analog signal processing in the light source driver circuit 20 so that light beam emission can be controlled with the light quantity being increased in the edge portions for a pixel recording time period having been adjusted to a desired time period.

The main control circuit 28 may also be of a type in which the drive signal generator 30 generates a light source driving signal capable of representing the driving timing and the light quantity level, and an additional driving signal capable of representing the timing at which the light quantity is increased in the edge portions and the light quantity level to be raised, and the thus generated driving signals are both outputted from the drive signal generator 30 to the light source driver circuit 20, which drives the light sources such as the LDs in accordance with the respective driving signals. Alternatively, the main control circuit 28 may be of a type in which the drive signal generator 30 generates a synthesis driving signal of the light source driving signal and the additional driving signal, and the thus generated synthesis driving signal is then outputted from the drive signal generator 30 to the light source driver circuit 20, which drives the light sources such as the LDs in accordance with the synthesis driving signal. In these cases, the target light quantity level parameter and the edge light quantity level parameter are set in the target light quantity DAC and the edge light quantity DAC (not shown) in the main control circuit 28, respectively.

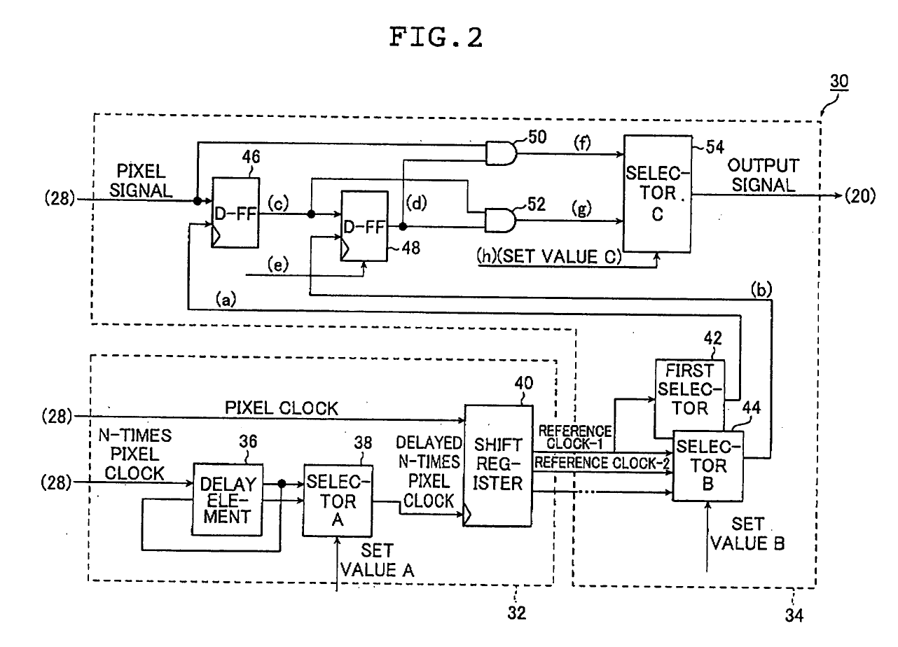

FIG. 2 shows an example of a specific circuit construction of the drive signal generating circuit 30 used in the main control circuit 28. As shown in FIG. 2, the drive signal generating circuit 30 includes a clock phase control section 32 and an output signal generation section 34. An exemplary construction in which the pixel recording time period is shortened for the respective pixel signals for use in exposing the pixels (e.g., pixel dots) for forming an image on the image forming material 12 when the recording area on pixels is larger with respect to a given resolution, to be more specific, when small points and fine lines are thickened because of their impaired reproducibility due to the increase in edge light quantity will be described below.

The reference pixel clock and the N-times pixel clock supplied from the main control circuit 28 are inputted into the clock phase control section 32, which generates reference clocks by delaying the phase of the reference pixel clock by predetermined periods and outputs the generated reference clocks.

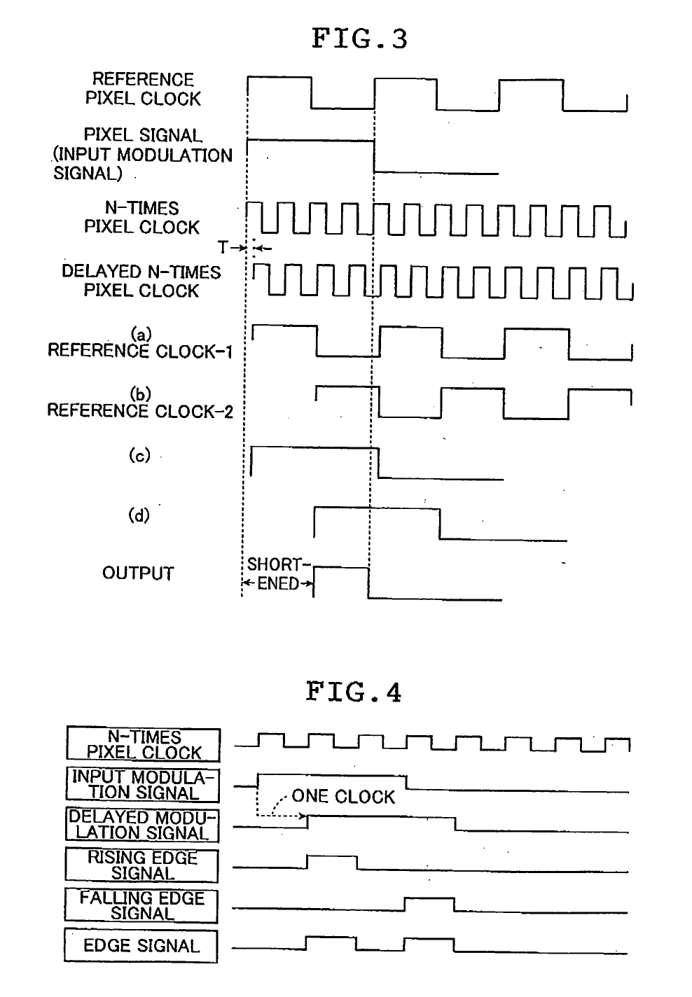

Also, FIG. 3 shows the state of a signal in each portion of the schematically shown clock phase control section 32 and output signal generation section 34. The schematic constructions of the clock phase control section 32 and the output signal generation section 34 and their action as the shortening of the pixel recording time period will be described below with reference to FIGS. 2 and 3.

The clock phase control section 32 includes a delay element 36, a selector A 38, and a shift register 40.

First, in the drive signal generator 30 of the main control circuit 28, a N-times pixel clock whose frequency has a period N times shorter than that of the reference pixel clock is generated and the generated N-times pixel clock is inputted into the delay element 36. The delay element 36 delays the inputted N-times pixel clock to generate signals (delay signals) and the generated delay signals are then inputted into the selector A 38. The selector A 38 selects one of the delay signals with reference to a set value A. The selected delay signal is set as a signal (delayed N-times pixel clock) where the N-times pixel clock is delayed on the basis of a period equal to or shorter than that of the reference pixel clock (in FIG. 3, the N-times pixel clock is delayed by a delay time T). The delay signal is used as a strobe signal in the shift register 40. The reference pixel clock is inputted into the shift register 40 as the input signal. From the shift register 40, reference clock 1, reference clock 2 and so on are outputted as the output signals. The output signals each serve as the reference clock signal obtained by delaying the reference pixel clock.

The output signal generation section 34 includes a first selector 42, a selector B 44, D-FFs (D-type flip-flops) 46 and 48, AND circuits 50 and 52, and a selector C 54.

The first selector 42 selects a reference clock 1 (a) as a reference clock obtained by delaying the reference pixel clock by a period equal to or shorter than that of the reference pixel clock, and uses the reference clock 1 (a) as a strobe signal for the D-FF 46.

In the illustrated case, the selector B 44 selects a reference clock 2 (b) with reference to a set value B as a reference clock obtained by delaying the reference pixel clock by its period and uses the reference clock 2 (b) as (a strobe signal for the D-FF 48.

The D-FF 46 outputs a signal (c) for establishing synchronization of the pixel signal synchronized with the reference pixel clock using the reference clock 1 (a) selected by the first selector 42. This operation is performed in order to establish synchronization using the delay signal from the selector B 44. The signal (c) is inputted into the D-FF 48 and the AND circuit 52.

The D-FF 48 is used to establish synchronization of the signal (c) using the reference clock 2 (b) selected by the selector B 44. When the signal (c) is inputted into the D-FF 48, a signal (d) is outputted from the D-FF 48. This signal (d) is a signal for establish synchronization of the signal (c) using the reference clocks 1 (a) and 2 (b) selected by the selector B 44, and is inputted into the AND circuits 50 and.52.

When the value “0” is set for instance in the selector B 44, that is, when shortening is not performed, this leads to an inconvenient situation where the signal (c) and the signal (d) are shifted by one reference pixel clock and the output signal from the D-FF 46 remains low. In this case, a signal having no shortening can be generated for the output signal by generating a signal (e) as a preset signal for the D-FF 46.

The AND circuit 50 generates a signal (f) in which a pixel signal front portion is shortened, using the pixel signal and the signal (d). This signal (f) is a signal which includes a delay by a period equal to or shorter than that of the reference pixel clock and a delay by the period of the reference pixel clock.

The AND circuit 52 generates a signal (g) in which the pixel signal front portion is shortened, using the signal (c) and the signal (d). This signal (g) is a signal including a delay by the period of the reference pixel clock.

The signals (f) and (g) are inputted into the selector C 54. A selection signal (h) is inputted into the selector C 54 so that the signal (g) is selected when there is no delay by the period equal to or shorter than that of the reference pixel clock, that is, when the set value C is “0”, whereas the signal (f) is selected when there is such a delay. The signals (f) and (g) are used as the signals whose pixel signal front portions have been shortened by the AND circuits to generate an output signal, which is then outputted. In this manner, the pixel recording time period is shortened.

A case where the pixel recording time period is shortened has been described above. The pixel recording time period may be inversely elongated by replacing the AND circuits with OR circuits. With this construction, when the recording pixel of an exposure optical system is narrow with respect to a resolution, to be more specific, when small dots and fine lines are narrowed because of the degradation in their reproducibility (halftone dot area ratio) due to the decrease in the entire light quantity in spite of the relative increase in the edge light quantity, the pixel recording time period is elongated, which enables extension of the main scanning width.

Also, by generating the signal (e) as a reset signal for the D-FF 48, it becomes possible to generate a signal containing no delay for the output signal.

Next, there will be described a method implemented in the main control circuit 28 and the light source driver circuit 20 for increasing the light quantity only in the edge portions by giving a large light quantity level to the rising edge portion and falling edge portion of the laser beam for use in exposing pixels (e.g., pixel dots) for forming an image on the image forming material 12.

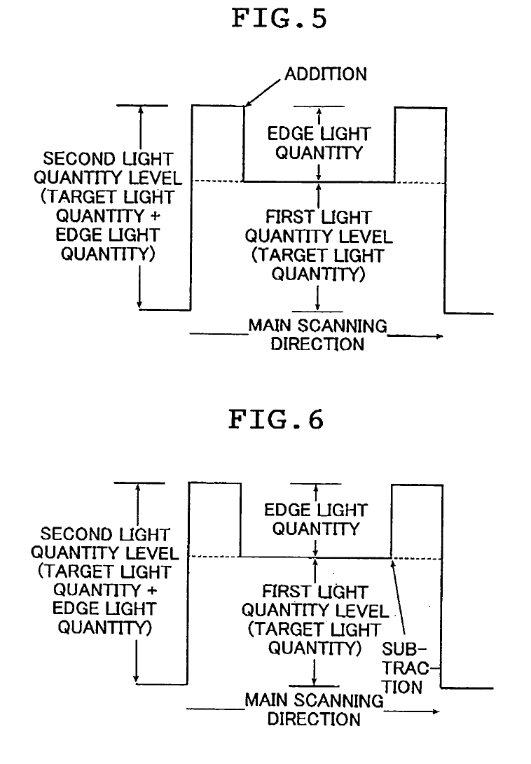

In the following description, as shown in FIGS. 5 to 8, the light quantity level at the time of exposure of a non-edge portion in one pixel (one pixel dot) is set as a “first light quantity level” and this level will be hereinafter referred to as the “target light quantity”. On the other hand, the light quantity level at the time of exposure of the edge portions is set as a “second light quantity level”. The second light quantity level is higher than the first light quantity level and the light quantity is increased in the edge portions by a difference between the first light quantity level and the second light quantity level. This difference (increased quantity) will be hereinafter referred to as the “edge light quantity”.

Therefore, there is obtained an equation:
“second exposure level=target light quantity (first exposure level)+edge light quantity”.

There are various methods for performing exposure while increasing the light quantity only in the edge portions using the first light quantity level and the second light quantity level. A method shown in FIG. 5 will be first described with which the second light quantity level is obtained by adding the edge light quantity to the target light quantity (first light quantity level).

First, the first light quantity level (target light quantity) and a value corresponding to the edge light quantity that is the quantity to be increased in the edge portions are set in the target light quantity DAC and the edge light quantity DAC included in the main control circuit 28 or the light source driver circuit 20, respectively. A pixel signal (image modulation signal) and an edge signal that make the DAC outputs effective are controlled to perform the respective DAC outputs.

According to the present invention, the timing at which the edge signal is given is controlled so as to give the edge signal at the timing of rising and falling of an image modulation signal, and the pixel recording time period between the rising and falling of the image modulation signal is also adjusted (shortened or elongated) to thereby improve the reproducibility of small points and fine lines and enhance the image quality.

Next, a method implemented in the main control circuit 28 (drive signal generator 30) for generating the edge signal for use in increasing the edge light quantity with respect to the image modulation signal (pixel signal) whose pixel recording time period has been adjusted (shortened or elongated) will be described.

FIG. 4 schematically shows an example of the edge signal generation method implemented in the drive signal generator 30 in the main control circuit 28 of the image forming apparatus 10 according to the present invention. In the example shown in FIG. 4, the image modulation signal (input modulation signal) has a width of three pixels and the edge signal has a width of one clock as can be seen from the comparison with the N-times pixel clock shown on the top in FIG. 4. It is needless to say that the pixel recording time period of the image modulation signal is adjusted (shortened or elongated).

First, the N-times pixel clock is used to generate a signal set at a timing delayed from the input modulation signal (image modulation signal) shown on the second line from the top in FIG. 4 by an edge signal time period (by one clock in this case). Next, in order to reflect the adjustment (shortening or delaying) of the pixel recording time period in the input modulation signal, a timing delayed from the falling edge portion of the input. modulation signal by the edge signal time period (one clock) is generated using the N-times pixel clock and the signal set in the above process is reset at the thus generated timing.

It should be noted here that the rising edge portion and the falling edge portion are detected by the rising edge/falling edge detector 26.

As a result, a delayed modulation signal (image modulation signal) shown on the third line from the top in FIG. 4 is obtained.

Next, a timing delayed from the rising edge portion of the thus generated delayed modulation signal by the edge signal time period (corresponding to one pixel) is generated using the N-times pixel clock and an edge signal in the rising edge portion (rising edge signal) shown on the fourth line from the top in FIG. 4 is obtained.

Also, a timing delayed from the falling edge portion of the original image modulation signal (input modulation signal) by the edge signal time period (by one clock) is generated using the N-times pixel clock and an edge signal in the falling edge portion (falling edge signal) shown on the fifth line from the top in FIG. 4 is obtained.

Lastly, by implementing an OR operation on the rising edge signal and the falling edge signal, an edge signal shown on the bottom in FIG. 4 is generated.

There can be a case where the edge signal has a longer time period than the delayed modulation signal (image modulation signal), so that it is required to implement an AND operation of the edge signal and the delayed image modulation signal.

Further, the delayed modulation signal has a delayed drawing-start timing compared to the original image modulation signal (input modulation signal), so that it is required to-shift the drawing-start timing in accordance with the edge signal time period in the system.

Then, as described above, the target light quantity and the edge light quantity initially set in the main control circuit 28 or the light source driver circuit 20 are used to control the increase in light quantity in the rising edge portion and the falling edge portion based on the edge signal generated in the drive signal generator 30.

FIG. 5 shows a state of the light quantity control. As shown in FIG. 5, in the non-edge portion, exposure is performed using the target light quantity (first light quantity level) and, in the rising edge portion and the falling edge portion, exposure is performed using the second light quantity level obtained by adding the edge light quantity to the first light quantity level.

A method of producing a waveform where the light quantity is increased only in the edge portions is not limited to the method with which the second light quantity level is obtained by adding the edge light quantity to the first (target) light quantity level, and there are several other methods.

For instance, as shown in FIG. 6, the first (target) light quantity level may be obtained by subtracting the edge light quantity from the second light quantity level for exposure of the edge portions.

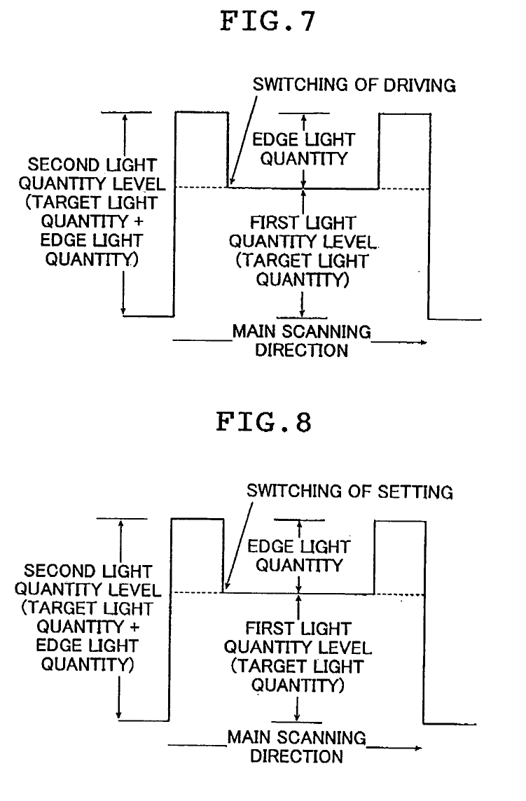

Alternatively, as shown in FIG. 7, the first (target) light quantity level and the second light quantity level may be separately held and switched from one to the other depending on whether the non-edge portion or the edge portions are to be exposed, and driving may be performed so that the non-edge portion and the edge portions are respectively exposed at their corresponding light quantity levels. That is, the driving at the first light quantity level may be performed using a signal except the edge signal of the modulation signal (modulation signal XOR edge signal) and the driving at the second light quantity level may be performed using the edge signal.

Still alternatively, as shown in FIG. 8, values corresponding to the first light quantity level (target light quantity) and the second light quantity level (target light quantity+edge light quantity) may be set for one DAC at an appropriate timing to change the DAC output thereby increasing the light quantity level only in the edge portions.

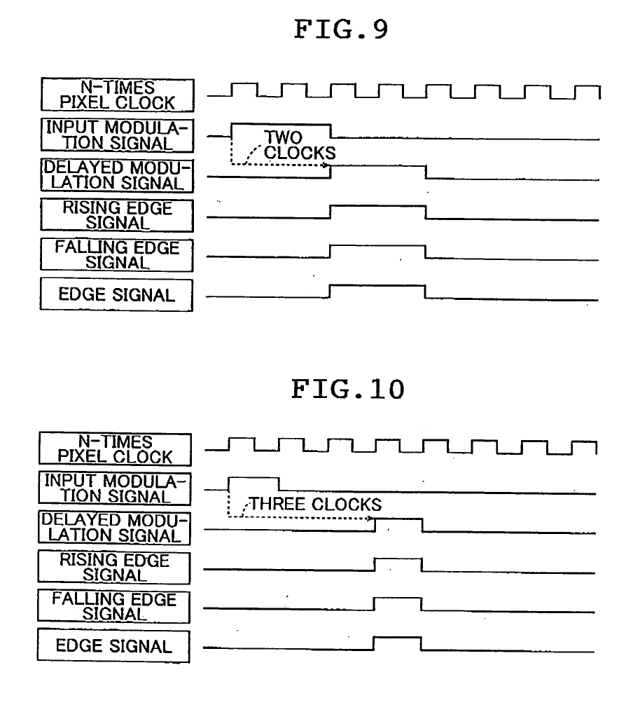

The edge signal is not limited to the example shown in FIG. 4 described above but may be those shown in FIGS. 9 and 10.

FIG. 9 shows a case where the modulation signal has a width corresponding to two clocks and the edge signal also has a width corresponding to two clocks. FIG. 10 shows a case where the modulation signal has a width corresponding to one clock and the edge signal has a width corresponding to three clocks.

When the edge signal to be added has a time period equal to or longer than the pixel recording time period of the modulation signal (modulation signal time period), the edge signal to be added can be set as described below.

A first timing delayed from the raising edge portion of the modulation signal by the edge signal time period is generated and the light quantity level is reset based on the generated first timing. Then, when the modulation signal time period is equal to or shorter than the edge signal time period after the first timing, the subsequent light quantity level is not set.

It should be noted that, although not shown, the generation circuit for generating the respective signals shown in the time charts of FIGS. 4, 9 and 10 are not limited in any particular way. The timing circuit in the exposure Circuit as proposed by commonly assigned Japanese Patent Application No. 2002-301951 is applicable, and the generation circuit may be of any type so long as the respective signals shown in the time charts mentioned above can be generated.

According to-the embodiments as described above, the light quantity level is raised only in the edge portions of a light beam for exposing pixels (pixel dots) for forming an image and the pixel recording time period is adjusted (shortened or elongated) in combination with the raising of the light quantity level, so that even if the light quantity is increased, there is prevented a situation where vertical fine lines and horizontal fine lines become different from each other in line width and image quality is degraded. As a result, it becomes possible to enhance the image quality.

Also, at the time of defocusing, a beam shape is changed and therefore a recording line width determined by the threshold value for image forming material varies. In addition, occurrence in sensitivity variation also changes the threshold value for image forming material and varies the recording line width. In this case, there is apprehension that the reproductivity of small dots and fine lines may be impaired to cause degradation in image quality such as variation in halftone dot area ratio or unevenness. However, it becomes possible to improve the reproducibility of small dots and fine lines and to eliminate the variation in halftone dot area ratio and unevenness by adjusting the pixel recording time period and/or increasing the light quantity only in the edge portions. As a result, it becomes possible to improve the image quality.

Further, by increasing the light quantity only in the edge portions, it becomes possible to prevent side effects occurring when the light quantity is increased in its entity, such as image defects resulting from the off-balance between white lines and black lines (which particularly conspicuously appears when a beam diameter is not narrowed) or the occurrence of aberration and the shortening of the life span of the laser.

Here, there is another apprehension that even when the light quantity is increased only in the edge portions in the manner described above, vertical fine lines and horizontal fine lines may become different from each other in line width and the image quality may be degraded. In view of this problem, the pixel recording time period is adjusted (shortened or elongated) so that the light quantity can be increased only in an intended rising or falling edge portion to-achieve improvement in image quality.

In the embodiments described above, the drive signal generator 30 of the main control circuit 28 generates a pixel signal (image modulation signal) whose pixel recording time period has been adjusted (shortened or elongated), and the main control circuit 28 or the light source driver circuit 20 generates an edge signal for use in increase in edge light quantity with respect to the adjusted pixel signal or generates a synthesis signal of both the signals. However, the present invention is not limited to these embodiments. For instance, a synthesis signal of the pixel signal and the edge signal may be generated in the main control circuit 28 or the light source driver circuit 20 before the pixel recording time period of the synthesis signal is adjusted (shortened or elongated). The adjusted pixel signal, the edge signal or the synthesis signal of the two signals may be generated in any way, if the increase in edge light quantity and the improvement in reproducibility of small points and fine lines are finally attained by the edge signal corresponding to the pixel signal (image modulation signal) whose pixel recording time period has been adjusted (shortened or elongated), which leads to the improvement in image quality. In addition, the adjusted pixel signal and the edge signal, or the synthesis signal of the two signals may be generated in one or more circuits selected from the main control circuit 28, the drive signal generator 30 and the light source driver circuit 20.

The image forming method and apparatus of the present invention have been described in detail above with reference to various embodiments and examples, but the present invention is not limited to the embodiments and examples described above and it is of course possible to make various modifications and changes without departing from the gist of the present invention.

1. An image forming method in which an image forming material is exposed to light beams to form an image, comprising:
a step of setting a first light quantity level and a second light quantity level that is higher than the first light quantity level or a predetermined light quantity level representing a difference between the second light quantity level and the first light quantity level;
a step of adjusting a pixel recording time period of a pixel signal to be subjected to pixel recording for forming the image on said image forming material;
a step of generating a first signal for driving said first light quantity level based on said pixel signal; and
a step of generating a second signal for driving said second light quantity level or said predetermined light quantity level based on said pixel signal,
wherein the pixel recording time period of said pixel signal is adjusted in accordance with a combination of said first signal and said second signal, and
wherein said image forming material is exposed to the light beams in said first light quantity level and in said second light quantity level based on the combination of said first signal and said second signal thereby performing the pixel recording on said image forming material.

2. The image forming method according to claim 1,
wherein said first signal is said pixel signal for driving said first light quantity level, said second signal is an edge signal for said pixel signal which drives said predetermined light quantity level, and
wherein said predetermined light quantity level is added to said first light quantity level to obtain said second light quantity level, or said predetermined light quantity level is subtracted from said second light quantity level to obtain said first light quantity level.

3. The image forming method according to claim 2,
wherein a delayed pixel signal is generated by detecting a raising edge portion and a falling edge portion of said pixel signal, generating a first timing delayed from the raising edge portion of said pixel signal by an edge signal time period, setting the delayed pixel signal at said first timing, generating a second timing delayed from the falling edge portion of said pixel signal by said edge signal time period, and resetting said delayed pixel signal at said second timing, and
wherein a third timing delayed from the raising edge portion of said delayed pixel signal by said edge signal time period is generated, a first edge signal in said raising edge portion of said delayed pixel signal is generated at said first timing and said third timing, and a second edge signal in the falling edge portion of said delayed pixel signal is generated based on the falling edge portion of said pixel signal and said second timing.

4. The image forming method according to claim 3, wherein said edge signal for said pixel signal is obtained as a logical product of said first edge signal and said second edge signal with said delayed pixel signal.

5. The image forming method according to claim 1,
wherein said second signal is an edge signal for said pixel signal, said first signal is a residual signal obtained by subtracting said edge signal from said pixel signal, and
wherein said residual signal is used to drive said first light quantity level and said edge signal is used to drive said second light quantity level.

6. The image forming method according to claim 5,
wherein a delayed pixel signal is generated by detecting a raising edge portion and a falling edge portion of said pixel signal, generating a first timing delayed from the raising edge portion of said pixel signal by an edge signal time period, setting the delayed pixel signal at said first timing, generating a second timing delayed from the falling edge portion of said pixel signal by said edge signal time period, and resetting said delayed pixel signal at said second timing, and
wherein a third timing delayed from the raising edge portion of said delayed pixel signal by said edge signal time period is generated, a first edge signal in said raising edge portion of said delayed pixel signal is generated at said first timing and said third timing, and a second edge signal in the falling edge portion of said delayed pixel signal is generated based on the falling edge portion of said pixel signal and said second timing.

7. The image forming method according to claim 6, wherein said edge signal for said pixel signal is obtained as a logical product of said first edge signal and said second edge signal with said delayed pixel signal.

8. The image forming method according to claim 1,
wherein said first signal is used to drive said first light quantity level and said second signal is used to drive said second light quantity level, and
wherein said first light quantity level is set at a timing at which said first signal for driving said first light quantity level is started, and said second light quantity level is set at a timing at which said second signal for driving said second light quantity level is started.

9. The image forming method according to claim 6, wherein the raising edge portion and the falling edge portion of said pixel signal are detected, said first timing delayed from the raising edge portion of said pixel signal by the edge signal time period is generated and used to set said second light quantity level, said second timing further delayed from said first timing by said edge signal time period is generated, said first light quantity level is set at said first timing, said second light quantity level is set in said raising edge portion, and a third timing delayed from said falling edge portion by said edge signal time period is generated and is used to reset said second light quantity level to an original light quantity level.

10. An image forming apparatus with which an image forming material is exposed to light beams to form an image, comprising:
means for adjusting a pixel recording time period of a pixel signal to be subjected to pixel recording for forming the image on said image forming material;
means for setting a first light quantity level;
means for setting a second light quantity level that is higher than the first light quantity level or a predetermined light quantity level representing a difference between said second light quantity level and said first light quantity level;
means for generating a first signal for driving said first light quantity level based on said pixel signal; and
means for generating a second signal for driving said second light quantity level or said predetermined light quantity level based on said pixel signal,
wherein said adjusting means adjusts the pixel recording time period of said pixel signal in accordance with a combination of said first signal and said second signal, and
wherein said image forming material is exposed to the light beams in said first light quantity level and in said second light quantity level based on the combination of said first signal and said second signal thereby performing the pixel recording on said image forming material.

11. The image forming apparatus according to claim 10,
wherein said first signal is said pixel signal for driving said first light quantity level, said second signal is an edge signal for said pixel signal which drives said predetermined light quantity level, and
wherein the image forming apparatus further comprises means for obtaining said second light quantity level by adding said predetermined light quantity level to said first light quantity level, or means for obtaining said first light quantity level by subtracting said predetermined light quantity level from said second light quantity level.

12. The image forming apparatus according to claim 11, which further comprises:
means for detecting a raising edge portion and a falling edge portion of said pixel signal;
means for generating a delayed pixel signal by generating a first timing delayed from the raising edge portion of said pixel signal by an edge signal time period, setting the delayed pixel signal at said first timing, generating a second timing delayed from the falling edge portion of said pixel signal by said edge signal time period, and resetting said delayed pixel signal at said second timing;
means for generating a third timing delayed from the raising edge portion of said delayed pixel signal by said edge signal time period and for generating a first edge signal in said raising edge portion of said delayed pixel signal at said first timing and said third timing; and
means for generating a second edge signal in the falling edge portion of said delayed pixel signal based on the falling edge portion of said pixel signal and said second timing.

13. The image forming apparatus according to claim 12, wherein said edge signal for said pixel signal is obtained as a logical product of said first edge signal and said second edge signal with said delayed pixel signal.

14. The image forming apparatus according to claim 10,
wherein said second signal is an edge signal for said pixel signal, said first signal is a residual signal obtained by subtracting said edge signal from said pixel signal, and
wherein said residual signal is used to drive said first light quantity level and said edge signal is used to drive said second light quantity level.

15. The image forming apparatus according to claim, 14, which further comprises:
means for detecting a raising edge portion and a falling edge portion of said pixel signal;
means for generating a delayed pixel signal by generating a first timing delayed from the raising edge portion of said pixel signal by an edge signal time period, setting the delayed pixel signal at said first timing, generating a second timing delayed from the falling edge portion of said pixel signal by said edge signal time period, and resetting said delayed pixel signal at said second timing;
means for generating a third timing delayed from the raising edge portion of said delayed pixel signal by said edge signal time period and for generating a first edge signal in said raising edge portion of said delayed pixel signal at said first timing and said third timing; and
means for generating a second edge signal in the falling edge portion of said delayed pixel signal based on the falling edge portion of said pixel signal and said second timing.

16. The image forming apparatus according to claim 15, wherein said edge signal for said pixel signal is obtained as a logical-product of said first edge signal and said second edge signal with said delayed pixel signal.

17. The image forming apparatus according to claim 10,
wherein said first signal is used to drive said first light quantity level and said second signal is used to drive said second light quantity level, and
wherein the image forming apparatus further comprises:
means for setting said first light quantity level at a timing at which said first signal for driving said first light quantity level is started; and
means for setting said second light quantity level at a timing at which said second signal for driving said second light quantity level is started.

18. The image forming apparatus according to claim 17, which further comprises:
means for detecting a raising edge portion and a falling edge portion of said pixel signal;
means for generating a first timing delayed from the raising edge portion of said pixel signal by an edge signal time period and setting said second light quantity level at said first timing;
means for generating a second timing which is further delayed from said first timing by said edge signal time period and setting said first light quantity level at said second timing; and
means for obtaining an original light quantity level by setting said second light quantity level in said falling edge portion, generating a third timing delayed from said falling edge portion by said edge signal time period, and resetting said second light quantity level at said third timing.
